(19) United States
(12) Patent Application Publication
(10) Pub. No.: US 2010/0238308 A1
(43) Pub. Date: Sep. 23, 2010

(54) ELECTRONIC DEVICE WITH IMAGE STABILIZATION MECHANISM

(75) Inventor: JEN-TSORNG CHANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/635,845

(22) Filed: Dec. 11, 2009

(30) Foreign Application Priority Data
Mar. 17, 2009 (CN) 200910300906.4

(51) Int. Cl. H04N 5/228

(52) U.S. Cl. 348/208.99; 348/E05.031

(57) ABSTRACT

An exemplary electronic device includes a housing, a lens module, a light source, an image sensor module, and an image processor. The lens module is received in the housing and used to receive light from an object. The light source is configured for projecting a light beam to the object, and forming a bright spot on the object. The image sensor module is configured for capturing images of the object and the bright spot. The image processor is configured for computing a change in the position of an image of the bright spot when displacement of the electronic device occurs, computing a displacement of the electronic device based on the change in the position of the image of the bright spot, and processing the captured image of the object based on the computed displacement such that the captured image is corrected.

### BACKGROUND

1. Technical Field

The present disclosure relates to electronic devices and, particularly, to electronic devices with electronic image stabilization mechanisms.

2. Description of Related Art

With the ongoing development of optical imaging technology, image capturing function is now widely employed in a variety of electronic devices, such as mobile phones, notebooks, and personal digital assistants (PDAs).

Lens modules and image sensors are key components for taking photos. In normal image capturing by an image capturing device such as a camera, light from an object propagates to a predetermined region of the camera, such as a central region of an image sensor of the camera. That is, an image plane of the object is located precisely on the image sensor, and thus a stabilize, clear image is obtained. However, during image capturing, both the lens module and the image sensor may move relative to the object due to a user's inadvertence, and simultaneously the lens module and the image sensor remain fixed relative to each other. When this happens, the light from the object may not propagate to the image sensor as intended. That is, the image plane of the object may no longer be precisely on the image sensor, resulting in a blurry image.

Image stabilization mechanisms that use motors have been devised. The motor compensates for unwanted movement by shifting the image sensor to the image plane of the object. However, the motor is typically bulky and consumes a great deal of electrical energy. In particular, the image sensor may have to be driven again and again each time image capturing is performed.

Therefore, an electronic device which can overcome the above mentioned problems is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views, and all the views are schematic.

FIG. 1 is a cross-sectional view of an electronic device according to a first embodiment of the present invention.

FIG. 2 is a plan view showing movement of a bright spot image after vibration of the electronic device of FIG. 1.

FIG. 3 is a cross-sectional view of an electronic device according to a second embodiment of the present invention.

### DETAILED DESCRIPTION

Various embodiments will now be described in detail below with reference to the drawings.

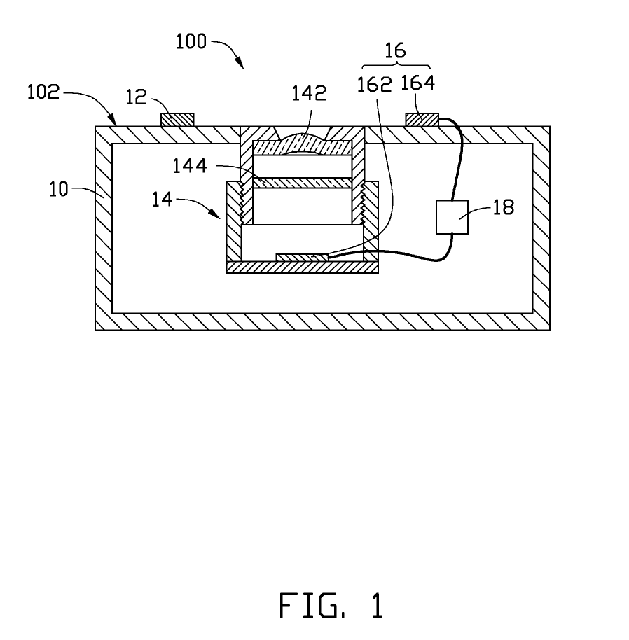

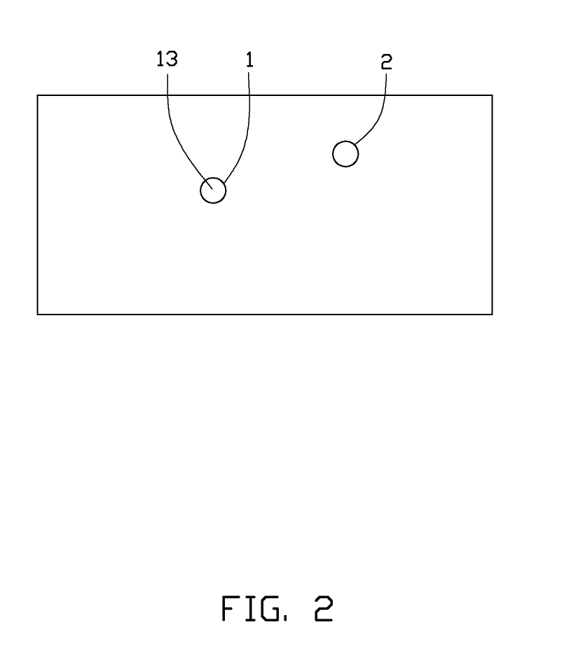

Referring to FIGS. 1-2, an electronic device 100 according to a first embodiment is shown. The electronic device 100 includes a housing 10, a point light source 12, a lens module 14 received in the housing 10, an image sensor module 16, and an image processor 18. Other components of the electronic device 100 are not shown. The electronic device 100 can be, for example, a camera, a mobile phone, a personal digital assistant, or a notebook.

The point light source 12 is an infrared light source. In particular, the point light source 12 can be an infrared light emitting diode (LED) or an infrared laser diode (LD), depending on different embodiments. The point light source 12 is configured for emitting a collimated infrared light beam to an object (not shown), thus forming an infrared “bright spot” 13 on the object. In the present embodiment, the point light source 12 is disposed on an outer surface 102 of the housing 10.

The lens module 14 has a lens 142 and a filter 144 received therein, in that order from an object side to an image side. The filter 144 is to filter infrared light. It can be understood that in other embodiments, the lens module 14 can include more than one lens, and/or can include other optical elements such as spacers.

The image sensor module 16 includes a first image sensor 162 and a second image sensor 164. The first image sensor 162 is used to capture an image of an object according to light beams received and manipulated by the lens module 14. The filter 144 can filter infrared light, thus preventing the bright spot 13 from being sensed by the first image sensor 162. The second image sensor 164 only detects infrared light. The second image sensor 164 is used to capture an image of the bright spot 13. In the present embodiment, the second image sensor 164 is disposed on the outer surface 102 of the housing 10. The first image sensor 162 can be, for example, a charge coupled device (CCD) sensor or a complementary metal oxide semiconductor (CMOS) transistor sensor. The second image sensor 164 can be, for example, a CCD sensor or a CMOS transistor sensor.

Referring to FIG. 2, the electronic device 100 may be displaced during the exposure time when a user is taking a photo, for example due to shaking of the user's hands. When this happens, the bright spot 13 moves from an exemplary first position 1 to an exemplary second position 2 due to the displacement. The change in position of the bright spot 13 is detected by the second image sensor 164. Subsequently, the processor 18 computes the displacement (e.g., vibration) of the electronic device 100 based on the change in position of the bright spot 13. The processor 18 then processes a blurred image of the object to obtain a stabilized image of the object, based on the displacement (e.g., vibration) of the electronic device 100. The method of processing the blurred image can be, for example, deconvolution, geometric mean filtering, etc. Such methods should be well known to those skilled in the art.

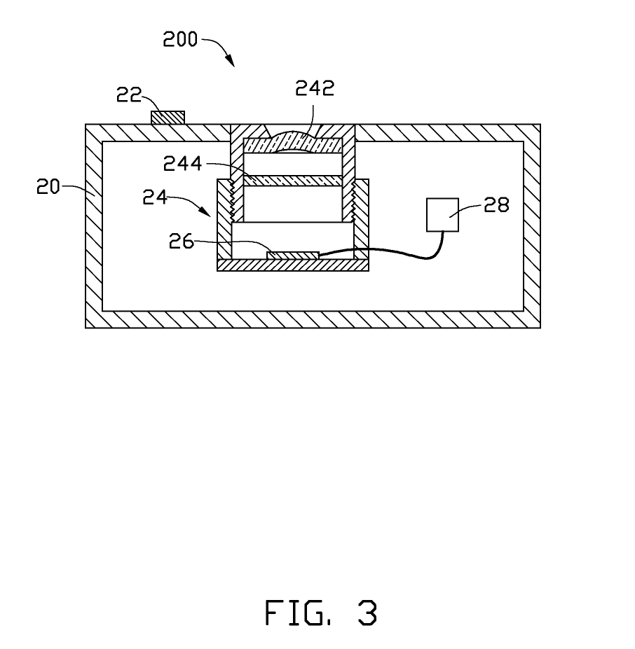

Referring to FIG. 3, an electronic device 200 according to a second embodiment is shown. The electronic device 200 includes a housing 20, a point light source 22, a lens module 24 received in the housing 20, an image sensor module 26, and an image processor 28. The lens module 24 includes a lens 242 and a filter 244. Visible and infrared light can pass through the filter 244. The wavelengths of the visible and infrared light passed are in ranges from 380 nm to 760 nm and from 800 nm to 940 nm, respectively. The image sensor module 26 detects the visible and infrared light, thus the image sensor module 26 can capture images of the object and the bright spot 13 simultaneously. The processor 28 processes the blurred image to obtain a stabilized image, and then the processor 28 removes the image of the bright spot 13 from the stabilized image to obtain a final image of the object.

No motor is required for correcting unwanted movement or vibration of the electronic device 100 or 200. Thus, the electronic device 100 or 200 can be compact, lightweight, and easy to make.

While certain embodiments have been described and exemplified above, various other embodiments from the foregoing disclosure will be apparent to those skilled in the art. The present invention is not limited to the particular embodiments described and exemplified, and is capable of considerable variation and modification without departure from the scope and spirit of the appended claims.

1. An electronic device comprising:
a housing;
a lens module received in the housing, the lens module configured for receiving light from an object;
a light source configured for projecting a light beam to the object, and forming a bright spot on the object;
an image sensor module configured for capturing images of the object and the bright spot; and
an image processor configured for computing a change in the position of an image of the bright spot when displacement of the electronic device occurs, computing a displacement of the electronic device based on the change in the position of the image of the bright spot, and processing the captured image of the object based on the computed displacement such that the captured image is corrected.

2. The electronic device of claim 1, wherein the light source is a point light source configured for emitting an infrared light beam.

3. The electronic device of claim 2, wherein the image sensor module includes a first image sensor and a second image sensor, the first image sensor is configured to capture an image of the object, and the second image sensor is configured to capture an image of the bright spot.

4. The electronic device of claim 3, wherein the second image sensor is disposed on an outer surface of the housing.

5. The electronic device of claim 3, further comprising a filter positioned at an object side of the first image sensor, the filter is configured for filtering infrared light, wherein the second image sensor is configured for detecting only infrared light.

6. The electronic device of claim 2, wherein the image sensor module is configured for capturing images of the object and the bright spot simultaneously.

7. The electronic device of claim 6, further comprising a filter positioned at an object side of the image sensor module, wherein the filter is configured for transmitting visible and infrared light.

8. The electronic device of claim 7, wherein wavelengths of the visible and infrared light transmitted are in ranges from 380 nm to 760 nm and from 800 nm to 940 nm, respectively.

9. The electronic device of claim 1, wherein when the displacement is vibration, the image processor is configured for computing a vibration of the electronic device.

10. The electronic device of claim 1, wherein the captured image is a blurred image.

11. The electronic device of claim 1, wherein the image sensor module comprises at least one item selected from the group consisting of a charge coupled device (CCD) sensor and a complementary metal oxide semiconductor (CMOS) transistor sensor.

12. An electronic device comprising:
a housing;
a lens module received in the housing, the lens module configured for receiving light from an object;
a light source configured for projecting a light beam to the object, and forming a bright spot on the object;
an image sensor module comprising a first image sensor and a second image sensor, the first image sensor configured for capturing an image of the object, the second image sensor configured for capturing a plurality of images of the bright spot; and
an image processor configured for identifying whether the positions of any of the plurality of images of the bright spot are different from each other; and on condition that any positions of the plurality of images of the bright spot are different from each other, computing a change between at least two such positions of images of the bright spot, computing a displacement of the electronic device based on the computed change, and processing the captured image of the object based on the computed displacement such that the captured image is corrected.

13. The electronic device of claim 12, wherein the light source is a point light source configured for emitting an infrared light beam.

14. The electronic device of claim 13, further comprising a filter, wherein the image sensor module includes a first image sensor and a second image sensor, the filter is positioned at an object side of the first image sensor, the filter is configured for filtering infrared light, and the second image sensor is configured for detecting only infrared light.

15. An electronic device comprising:
a housing;
a lens module received in the housing, the lens module configured for receiving light from an object;
a light source configured for projecting a light beam to the object, and forming a bright spot on the object;
an image sensor module configured for capturing images of the object and the bright spot simultaneously; and
an image processor configured for computing a change in the position of an image of the bright spot when displacement of the electronic device occurs, computing a displacement of the electronic device based on the change in the position of the image of the bright spot, and processing the captured image of the object based on the computed displacement such that the captured image is corrected.

16. The electronic device of claim 15, wherein the light source is a point light source for emitting an infrared light beam.

17. The electronic device of claim 16, wherein the electronic device comprises a filter, and the filter is configured for transmitting visible and infrared light.

18. The electronic device of claim 17, wherein wavelengths of the visible and infrared light transmitted are in ranges from 380 to 760 nm and from 800 to 940 nm, respectively.
